(19) United States
(12) Patent Application Publication
(10) Pub. No.: US 2005/0009201 A1
(43) Pub. Date: Jan. 13, 2005

(54) Method of spotting probe solution

(75) Inventor: Hitoshi Shimizu, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/885,753

(22) Filed: Jul. 8, 2004

(30) Foreign Application Priority Data
Jul. 10, 2003 (JP) 2003-195276

(51) Int. Cl. G01N 1/10

(52) U.S. Cl. 436/180

(57) ABSTRACT

A spotting pin contains a probe solution. The spot volume is determined such that the probe solution may not intrude into the neighboring spot area. A spot volume is calculated from a pore ratio of the membrane and the spot volume. The spotting time is determined from the spot volume. An end of the spotting pin is contacted to the spot area of the biochemical analysis unit, and the probe solution is spotted to the membrane which is pressed into the spot area. Then the spotted region becomes extended gradually. When the predetermined spotting time has passed, the spotting pin is upheld. The spot volume of the prove solution becomes uniform, and the mixing of the probe solution is prevented between the neighboring spot areas.

### BACKGROUND OF THE INVENTION

1. Field of the Invention

The present invention relates to a method of spotting a probe solution, and especially to a method of spotting the probe solution in a spot area formed in a biochemical analysis unit.

2. Description Related to the Prior Art

A biochemical analysis unit is used for analyzing substances derived from living organisms, for example, for analyzing base sequence in DNA. In the biochemical analysis unit, as described in Japanese Patent Laid-Open Publication No. 2002-355036, plural small through-holes are formed in a substrate, and adsorptive materials, such as porous materials and the like, are filled in the through-holes to form an adsorptive area (hereinafter a spot area). In each spot area, specific-binding substances (hereinafter probe) whose molecular structure and characteristics are known are fixed to the spot area. In the biochemical analysis unit, each spot area is separated. Accordingly, the measurement can be made with higher accuracy by using the biochemical analysis unit than a DNA micro array (or DNA tip). In the analysis of base sequence, the specific binding reaction of the probe is made to specific-binding substances (hereinafter target) complementary to the probe.

The base sequence and composition of the probe is known, and the probe can make a specific binding to hormones, tumor markers, enzymes, antibodies, antigens, abzymes, receptors, other proteins, ligand, nucleic acids, cDNA, DNA, mRNA, and the like. Further, the target is obtained as follows. Hormones, tumor markers, enzymes, antibodies, antigens, abzymes, receptors, other proteins, ligand, nucleic acids, cDNA, DNA, mRNA, and the like are extracted and isolated from the living organism, and the chemical treatments and the treatments of chemical modifications thereof are made. Thereafter, to these substances after the treatment are applied radioactive substances or fluorescent substances for labelling. Otherwise may be used reactive labeling substances composed of enzymes and substrates from which occur irradiation, coloration and fluorescence emission in contact to the enzymes. In this case, enzyme is the target.

For example, in the Publication No. 2002-355036, when the radioactive substances are used for labeling, the specific binding reaction is detected with used of stimulable phosphor sheet. In the stimulable phosphor sheet are formed areas (hereinafter photostimulable phosphor areas) containing photostimulable phosphors whose exposure is made in radioactive ray generated from radioactive substances. When the spot area of the biochemical analysis unit and the photostimulable phosphor areas of the stimulable phosphor sheet are closely contacted, the radioactive ray from the spot areas for making the specific-binding reaction makes the exposure of the stimulable phosphor areas. Thereafter, an exciting light is irradiated to the stimulable phosphor sheet to generate a stimulable light from the exposed stimulable phosphor area. The stimulable light is detected in a photoelectrical manner so as to generate a biochemical analysis data. The biochemical analysis of base sequence and the like in DNA is executed on the basis of the biochemical analysis data.

Nowadays to the biochemical analysis unit is required that the larger number of the spot areas is formed. Accordingly, when the probe solution is spotted on the spot areas formed with high density, the probe solution sometimes intrudes to the neighboring spot areas. In this case, the noise is generated in the obtained biochemical analysis data.

### SUMMARY OF THE INVENTION

An object of the present invention is to provide a method of spotting a probe solution to reduce the generation of noise in a data analysis.

Another object of the present invention is to provide a method of spotting a probe solution, to reduce the intrusion of the probe solution to the neighboring spot areas formed with high density in a biochemical analysis unit.

In order to achieve the object and the other object, in the method of spotting a probe solution of the present invention, a biochemical analysis unit is provided, and the probe solution is spotted in a spotting area including adsorptive materials. A pore ratio in volume is P, and a spot capacity of the maximal spot region formed by a through hole area of the spot area and thickness of the adsorptive material is V(m³). In this case, the spot volume S(m³) of the probe solution in the spotting area satisfies a following formula:
0.01×V×P≦S≦V×P.
The pore ratio p is preferably in the range of 60%-70%. The preferable adsorptive material is a porous material or a fiber material. Both of the porous material and the fiber material may be used simultaneously. The spot capacity V of the maximal spot region of the spot area is preferably in the range of 5×10⁻¹³ m³ to 10×10⁻¹³ m³. A spotting time for spotting the probe solution to the spot area is at least 0.1 second and at most 3 seconds.

According to the method of spotting the probe solution of the present invention, in the biochemical analysis unit the probe solution is spotted into the spotting area formed of the adsorptive material, and when the pore ratio in volume is P and a spot capacity of the maximal spot region formed by a through hole area of the spot area and thickness of the adsorptive material is V(m³), the spot volume S(m³) of the probe solution in the spotting area satisfies the formula of 0.01×V×P≦S≦V×P. Accordingly, necessary amount of the probe for specific binding reaction is fixed to the spot area, and the mix of the probes between the neighboring spot areas is prevented.

Further, as the spotting time for spotting the probe solution to the spot area is at least 0.1 second and at most 3 seconds, the necessary amount of the probe is spotted, and the fluctuation of the spotted amount of the probe solution is regulated. Furthermore, the mix of the probes between the neighboring spot areas is prevented.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a process drawing for explaining processes of series of biochemical analysis;

FIG. 2 is a perspective view of one embodiment of a biochemical analysis unit used for the present invention;

FIG. 3 is a sectional view of the biochemical analysis unit in FIG. 2;

FIG. 4 is a diagrammatic view for explaining a producing method of the biochemical analysis unit in FIG. 2;

FIGS. 5A & 5B are sectional view for explaining a producing method of the biochemical analysis unit in FIG. 2;

FIG. 6 is a sectional view for explaining a producing method of the biochemical analysis unit in FIG. 2;

FIG. 7 is a sectional view for explaining a producing method of another embodiment of a biochemical analysis unit in FIG. 2;

FIG. 8 is a sectional view of the biochemical analysis unit used in the present invention;

FIG. 9A is a sectional view of another embodiment of the biochemical analysis unit used in the present invention;

FIG. 9B is a exploded plan view of the biochemical analysis unit of FIG. 9A;

FIG. 10 is a perspective view of a spotting device used in the present invention;

FIG. 11A is a front view of one embodiment of a spotter used for the present invention;

FIG. 11B is a side view of the spotter of FIG. 11A;

FIG. 12 is a diagrammatic view of another embodiment of a spotter used for the present invention;

FIG. 13A is a partial view of another embodiment of a spotter used for the present invention;

FIG. 13B is a sectional view of another embodiment of the spotter of FIG. 13A;

FIG. 14 is a graph illustrating a relation of a contacting time of pin to the spotting quantity;

FIG. 15 is a sectional view of another embodiment of a biochemical analysis unit used in the present invention;

FIG. 16 is a flow chart of a method of spotting a probe solution according to the present invention;

FIGS. 17A-17D are sectional views illustrating the method of spotting the probe solution of the present invention.

### PREFERRED EMBODIMENTS OF THE INVENTION

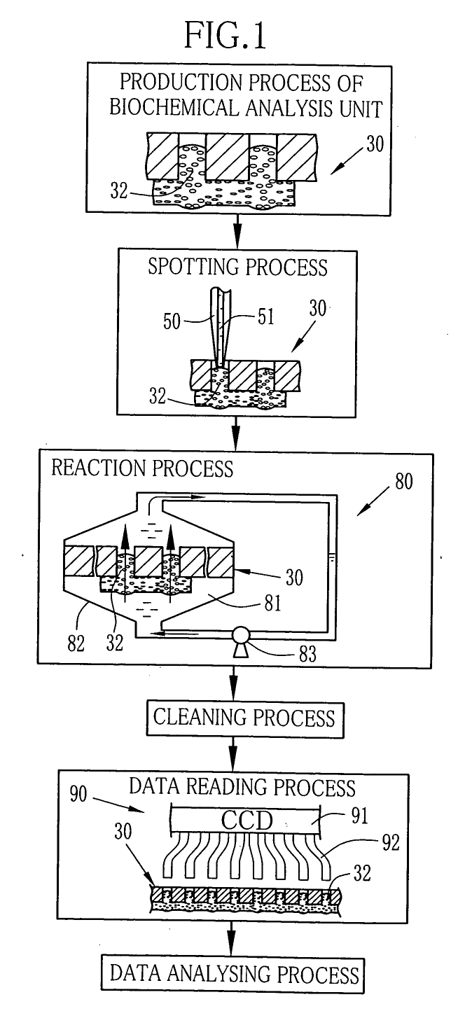

Preferable embodiments of the present invention will be explained in followings. As shown in FIG. 1, a biochemical analysis is made in sequence of a producing process of a biochemical analysis unit, a spotting process, a reaction process of specific binding reaction, a cleaning process, a data reading process and a data analyzing process. In the present invention, the specific binding reaction includes a hybridization reaction, an antigen-antibody reaction, a ligand-receptor reaction and the like.

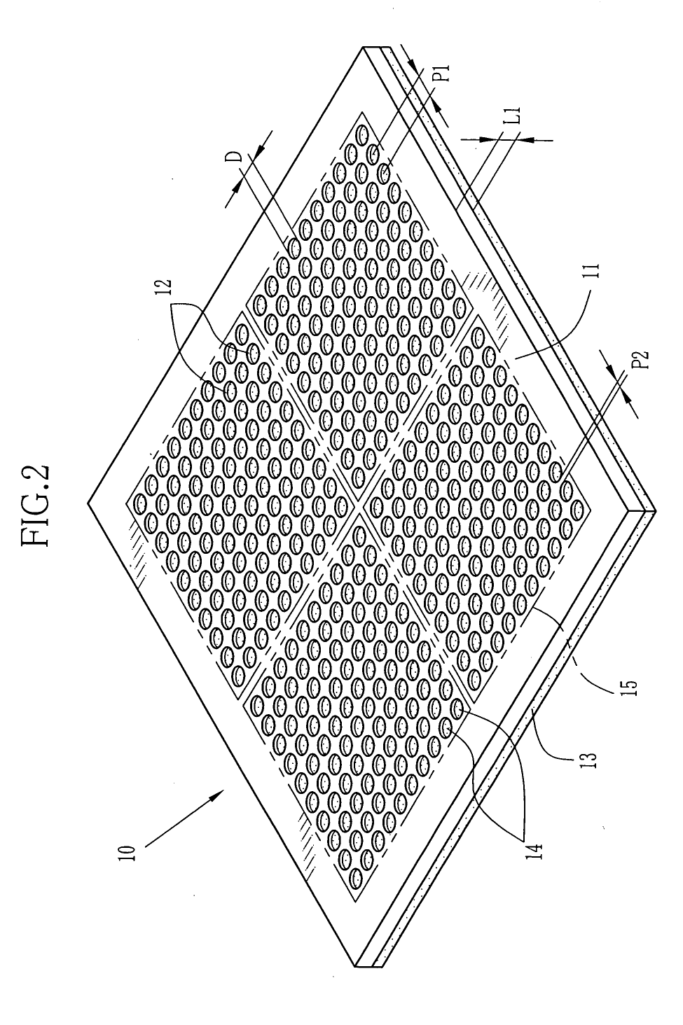

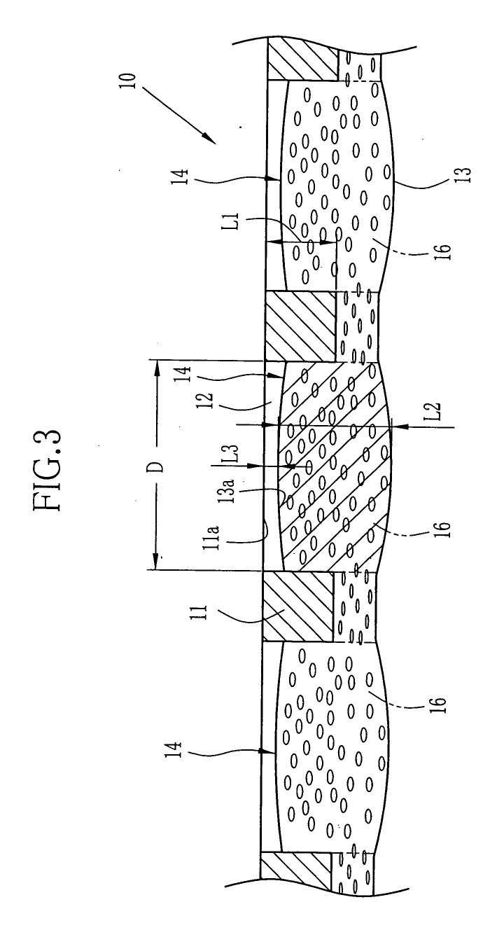

In FIG. 2, an embodiment of the biochemical analysis unit is illustrated, and a sectional view thereof is illustrated in FIG. 3. The biochemical analysis unit 10 has a substrate 11 in which through holes 12 are formed. An adsorptive material (hereinafter membrane) is pressed into the through holes 12 from a side of the substrate 11 so as to form spot areas 14. Further, the biochemical analysis unit 10 has plural spot area blocks (herein after blocks) 15 of generally rectangular form, while each block 15 has many spot areas 14. The blocks 15 are regularly arranged in the biochemical analysis unit 10, since in this arrangement the positioning is made easily for reading data. However, the present invention is not restricted in them.

When the thickness L1 of the substrate 11 is about 100 μm, the thickness L2 of the membrane 13 is preferably in the range of 130 μm to 180 μm. However, the present invention is not restricted in this range. A distance L3 between a plate surface la of the substrate 11 and a membrane surface 13a of the membrane 13 is preferably about 20 μm. A diameter and a thickness of a maximal spot region 16 are a diameter D of each through hole 12 and the thickness L2 of the membrane 13 respectively, such that the maximal spot region 16 may have a spot capacity V(m³).

Preferably, the membrane surface 13a is retracted from the plate surface to form a hollow. In this structure, when the probe solution is spotted in each spot are by a spotting device 40, it is prevented that the spotted probe solution spreads on the plate surface 11a to intrude into the other spot area. Further, the probe solution stay in the hollow until the probe solution entirely penetrates into the membrane 13. Further, the analysis is often made with use of a target provided with radioactive labeling substance. In this case, when the photostimulable phosphor is exposed to the radioactive ray generated from each spot area, the interference of the radioactive rays generated from the neighboring spot areas is prevented.

The preferable materials of the substrate 11 are materials to attenuate the light in order to prevent the diffusion of the light in the spot area 14 of the biochemical analysis unit 10. As the preferable materials, there are metals, ceramics, plastics and the like. The thickness L1 of the substrate 11 is preferably in the range of 50 μm to 1000 μm, and especially in the range of 100 μm to 500 μm.

As the metals, there are copper, silver, gold, zinc, lead, aluminum, titanium, tin, chromium, iron, nickel, cobalt, tantalum and the like. Further, alloys (stainless steel, brass, and the like) may be used as the metals. However the metals of the present invention are not restricted in them. Further, as the ceramics, there are alumina, zirconia and the like. However, the ceramics of the present invention are not restricted in them.

As the plastics, there are polyolefine (for example, polyethylene, polypropylene, and the like), polystyrene, acrylic resin (for example, polymethyl methacrylate and the like), polymers containing chlorine (for example, polyvinylchloride, polyvinylidenechloride and the like), polymers containing fluorine (for example, polyvinylidenefluoride, polytetrafluoroethylene, and the like), polymers contining chlorine and fluorine (for example, polychlorotrifluoroethylene and the like), polycarbonate, polyester (for example, polyethylenenaphthalate, polyethylenetelephthalate and the like), polyamide (for example, nylon-6, nylon-66 and the like), polyimide, polysulfone, polyphenylenesulfide, silicone resins (for example, polydiphenylsiloxane and the like), phenol resins (for example novolac and the like), epoxy resins, polyurethane, celluloses (for example, cellulose acetate, nitrocellulose and the like), and the like. Further, there are copolymers (for example, butadiene-styrene copolymer and the like) and materials of the blend of the above plastics. However, the plastics are not restricted in them.

When the plastic is used as the materials for the substrate, the formation of the through holes becomes easily, and it is therefore preferable. However, the attenuation of the light sometimes becomes hard, and the lights generated from the neighboring spots areas sometimes mix. Therefore it is preferable to fill the particles in the plastics to attenuate the light more over. Further, in order to attenuate the light, it is preferable to fill metal oxide particles or glass fibers in the plastic. As the metal oxides, there are silicon dioxide, alumina, titanium dioxide, iron oxide, copper oxide and the like. However, the metal oxides are not restricted in them. In the attenuation of the light, the light generated from the spot area transmits through a wall of the substrate, and thereby the strength of the light arriving at the neighboring spot are becomes lower, and preferably to at most one fifth, and especially to at most one tenth of the original strength.

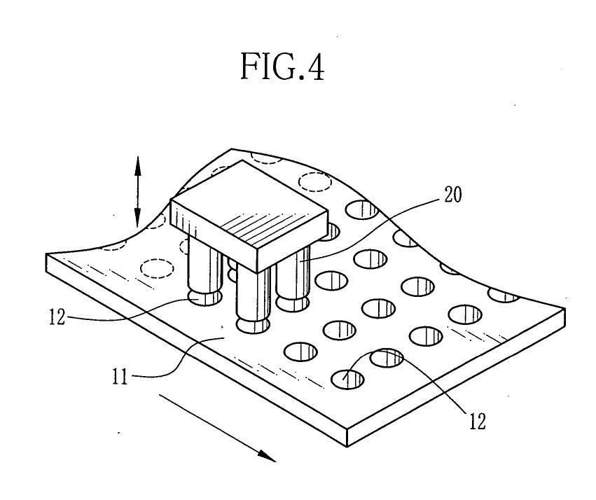

As methods of forming the through holes 12, there are punching method, electrochemical etching method, a method in which a laser beams generated by a exima laser and a YAG laser are applied to the substrate. However, the methods are not restricted in them. In accordance with the material of the substrate, the through holes are formed by adequate one of well-known methods. Note that the through holes 12 may be formed by a punching method in which pins 20 are used in FIG. 4.

In order to make the number of the through holes per the biochemical analysis unit higher, the area of the opening of each through hole is preferably less than 5 mm², particularly less than 1 mm², especially less than 0.3 mm², and more especially less than 0.01 mm², and most especially less than 0.001 mm². The shape of section of the through hole is not restricted in nearly-circular shaped form, and may be elliptic form.

The pitch P1 of the through holes 12 (or a distance between centers of two neighboring through holes) is preferably 50 μm-3000 μm, and the distance P2 between the through holes 12 (or the shortest distance between edges of the two neighboring through holes) are preferably 10 μm-1500 μm. Further, the number of the through holes 12 per the biochemical analysis unit is preferably 10/cm², particularly 100/cm², especially 500/cm², and most especially 1000/cm².

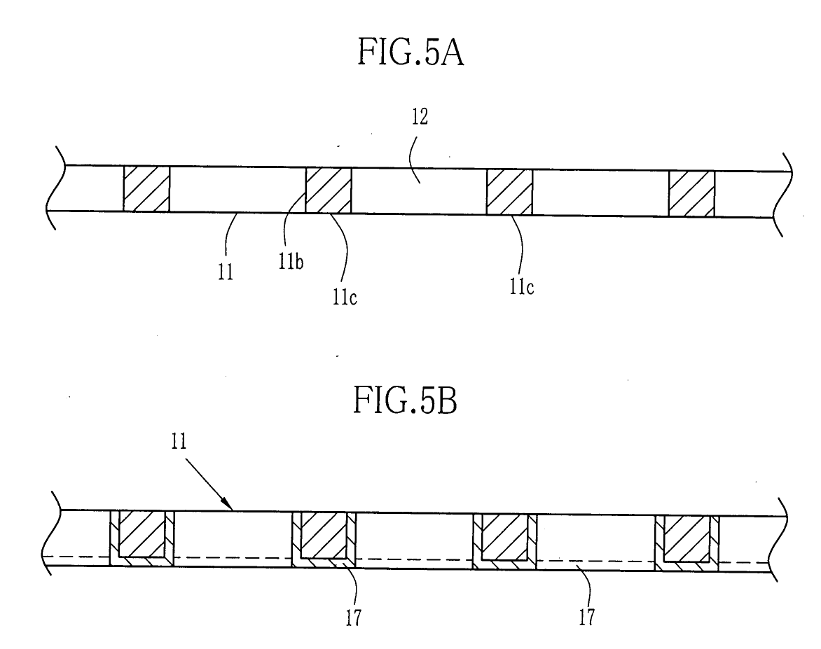

Surface treatment of the substrate 11 is made to form surface treatment layers 11b, 11c illustrated in FIG. 5A. Thus, The surface treatment layers 11b, 11c increase the adhesive property of the adhesive agent which will be explained in following. When metal, alloy (for example stainless steel and the like) are used as the material of the substrate 11, the surface treatment layers 11b, 11c are formed in any method of corona discharge, plasma discharge, or an anode oxidization method and the like. The surface treatment layers 11b, 11c have polar groups, such as carbonyl groups, carboxylic groups and the like, and therefore are metal oxide layers having hydrophilic properties.

As shown in FIG. 5B, the adhesive agent 17 is applied to the surface treatment layers 11b, 11c. Note that the method of forming the adhesive agent 17 is not restricted especially, and may be methods of roller coating, wire bar coating, dip coating, blade coating, air knife coating and the like. As the adhesive agent 17, styrenebutadiene rubber, acrylonitryl butadiene rubber are preferably used. However, the adhesive agent 17 is not restricted in them. Note that the excess adhesive agent 17 is removed by a blade or by thermal decomposition in illumination of a laser beam. Note that the processing of plate surface treatment and application of the adhesive agent may be removed in the present invention.

As the membrane 13 pressed into the spot area 14, porous material or fiber material is used. Further, the porous material and the fiber material may be used simultaneously. The membrane used in the present invention may be organic, inorganic, organic/inorganic porous material, or organic, inorganic fiber material. And the mixture of them may be used. Further, a pore ratio P in volume is preferably in the range of 60% to 70%, and the averaged pore diameter is preferably in the range of 0.2 μm to 3 μm.

The organic porous material is not restricted especially. However, it is preferable to use polymer. As the polymer, there are cellulose derivative (for example nitrocellulose, regenerated cellulose, cellulose acetate, cellulose acetate butyrate and the like), aliphatic polyamides (for example, nylon-6, nylon-6,6, nylon-4,10, and the like), polyolefines (for example, polyethylene, polypropylene and the like), polymers containing chlorine (for example, polyvinyl chloride, polyvinylidene chloride and the like), fluorocarbon resins (for example, polyvinylidene fluoride, polytetrafluoride, and the like), polycarbonate, polysulfone, alginic acid and derivatives thereof (for example, calcium alginate, alginic acid/polyricine polyion complex, and the like), collagen and the like. Further, copolymers or complexes (mixtures) of the polymers can be used.

The inorganic porous materials are not restricted especially. As the preferable inorganic porous material, there are metals (for example, platinum, gold, iron, silver, nickel, aluminum and the like), oxides of metals (for example, alumina, silica, titania, zeolite, and the like), salts of metals (for example, hydroxyapatite, calcium sulfate and the like), and complexes thereof. Further, carbon porous materials, such as activated carbon and the like, may be preferably used.

Further, the organic fiber materials and the inorganic fiber materials are not restricted especially. For example, the organic fiber materials may be the cellulose derivatives (described above), aliphatic polyamides and the like, and the inorganic fiber materials are glass fibers, metal fibers, and the like. Further, in order to increase the strength of the membrane 13, the fiber materials which are insoluble to the solvent for dissolving the porous materials may be contained in the membrane 13.

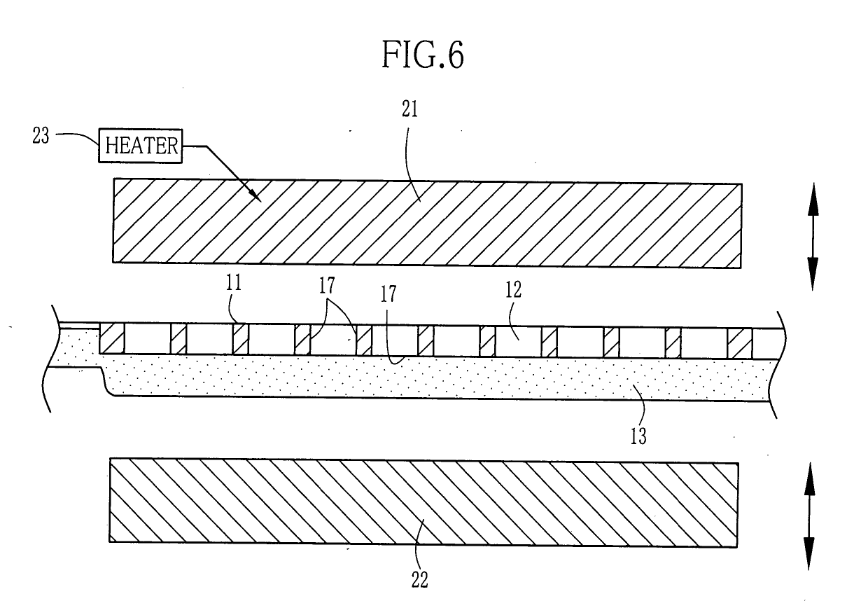

In FIG. 6, an embodiment for forming a spot area 14 by pressing the membrane 13 into the through holes 12 is shown. The substrate 11 and the membrane 13 are superimposed, and then pressed by press plates 21, 22. Thereafter, the substrate 11 and the membrane 13 are moved and the next press is preformed. Note that when the organic porous materials and/or organic fiber materials are used as the membrane 13, the press plate 21 is heated by a heater 23 such that the flexibility of the membrane 13 is increased to make the press easily.

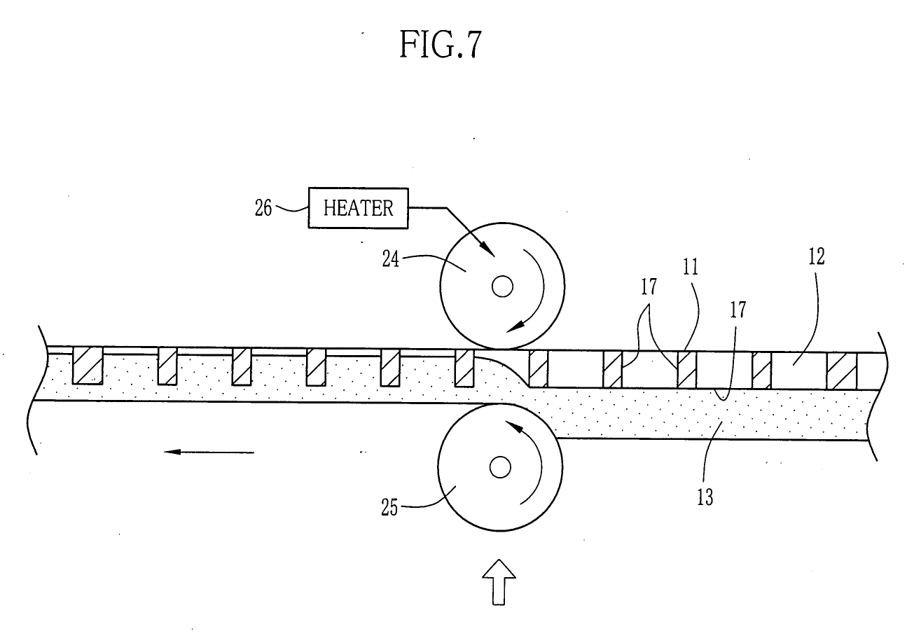

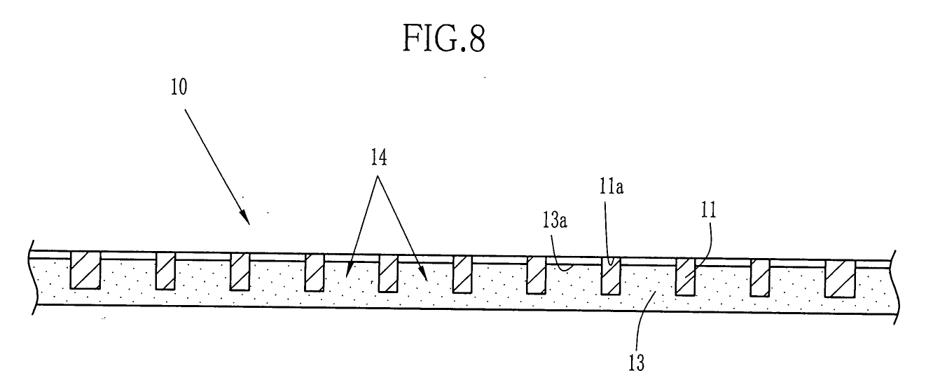

Further, another embodiment of pressing the membrane 13 into the through holes 12 with use of rollers 24, 25 is shown in FIG. 7. Also in this case, it is preferable that the heater 26 is attached to and heats the roller 24 that is provided in a side of the substrate 11. Further, it is preferable that at least one of the rollers 24,25 is a press roller for pressing the membrane 13 into the through holes 12. A sectional view of the biochemical analysis unit 10 obtained in the above producing process is shown in FIG. 8. The membrane 13 is pressed such that part thereof may enter into the through holes 12 so as to form the spot area 14.

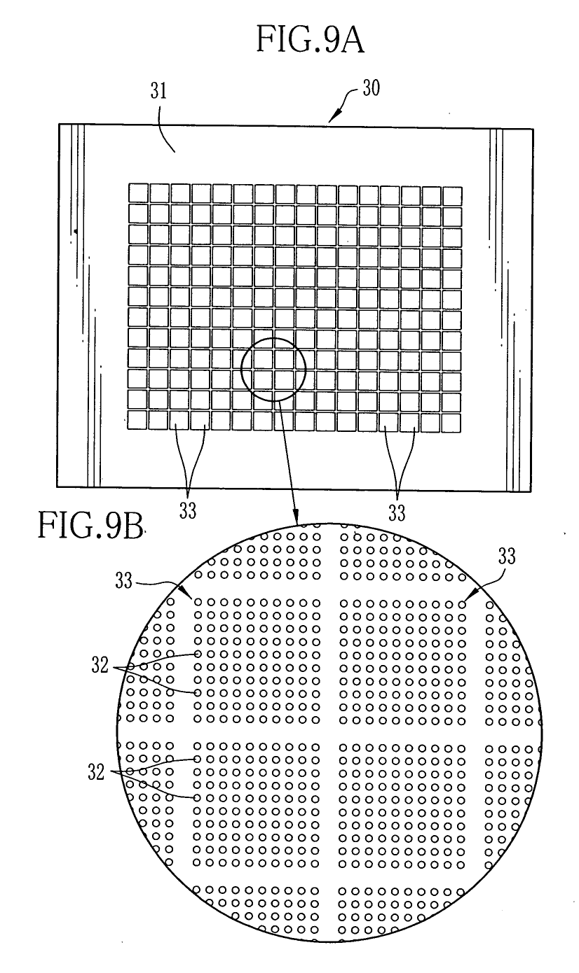

In the biochemical analysis unit used in the present invention, the spot areas, the numbers of the blocks and the spot areas in each block, the size and arrangement of the spot areas are not restricted in FIG. 2. The preferable biochemical analysis unit has so many spot areas that the situations of the reactions in each spot area can be known simultaneously in the biochemical analysis. For example, in a biochemical analysis unit 30 in FIGS. 9A&9B, the spot areas 32 whose diameters are 300 μm are formed in a substrate 31 of 70 mm×90 mm (see, FIG. 9B). In a block 33, 10×10 spot areas 32 are formed, and 12×16 of the blocks 33 are arranged (see, FIG. 9A). In the biochemical analysis unit 30, the number of the formed spots areas is 19200, and the data can be obtained in the analysis for one batch as same as in DNA microarray with high accuracy. Note that the section of the spot area has nearly circular form, the distance between centers of the neighboring spot areas is preferably 400 nm.

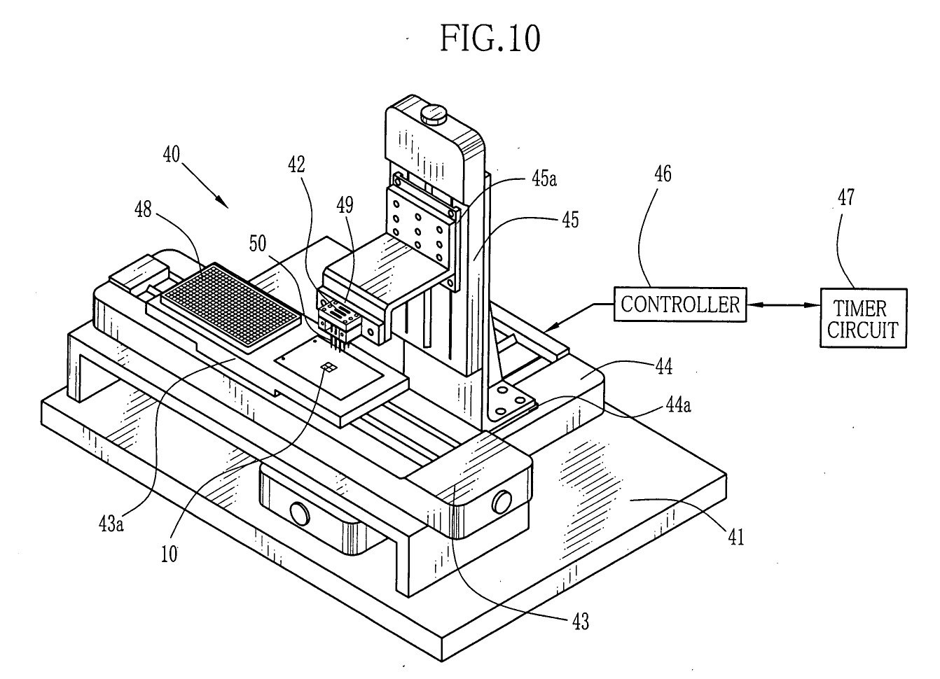

In FIG. 10, the spotting device 40 has a substrate 41 a spot head 42 attached to the substrate 41, a controller 46 for controlling overall X-, Y-, and z-slide units 43, 44, 45, and a timer circuit 47. In each slide unit 43-45, screws for transmitting a driving force of a servomotor (not shown) are used to move each slide unit along a guide by rotating the transmitting screw.

In the X-slide unit 43, an X-table 43a moves into one direction. In the Y-slide unit 44, a Y-table 44a moves into an orthogonal direction to the one direction. In the Z-slide unit 45, a Z-table 45a moves in a perpendicular direction to these two directions. Further, a well plate 48 in which prove solutions are separately injected and a biochemical analysis unit 10 are positioned on the X-table 43a. Note that the probe solution contains as a solute the substances derived from the living organism, such as DNA and the like, while the structures of the materials are known. The spot head 42 is provided for a support plate 49 provided to the Z-table 45a, and includes spotting pins 50 as a probe spotter (or a spotting means). Each slide unit 43-45 is driven such that the probe solutions may be soaked up from the well plate 48 into the spotting pins 50, and apply the probe solutions to the respective spot areas of the biochemical analysis unit 10.

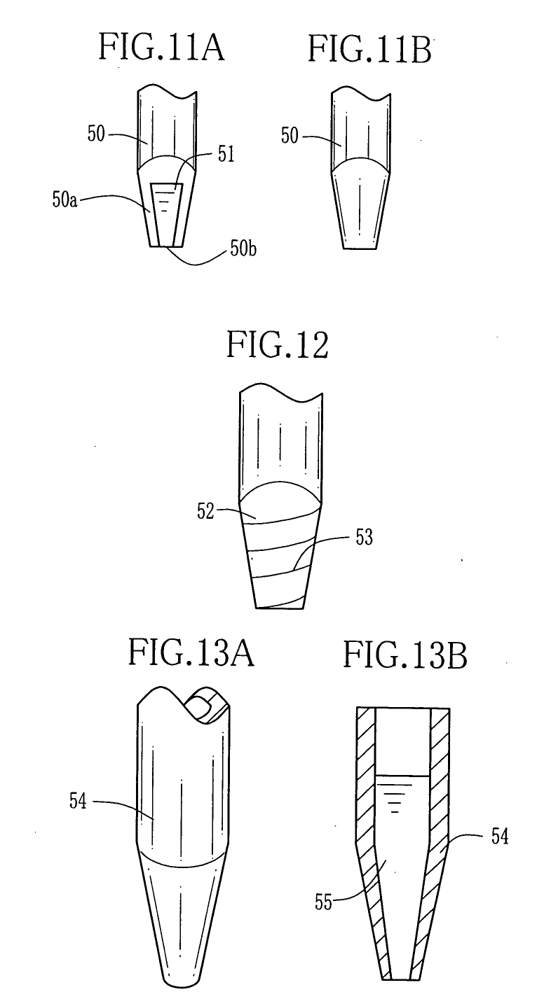

As shown in FIGS. 11a & 11b, a channel 50a are formed in a top of each spotting pin 50, and the probe solution 51 is collected in the channel 50a. Note that the form of the spotting means of the prove solution that is used in the present invention is not restricted the spotting pin 50, and may a be pin whose end portion 52 has a spiral groove which is shown in FIG. 12. In this case, the prove solution 53 is soaked up in the groove. Further, the spotting means is not restricted in the pin. As shown in FIG. 13, a capillary 54 in which the probe solution 55 is soaked up may be used. Further, the spot diameter of the opening of an opening 50b is not restricted especially. However, it is preferably in the range of 5×10⁻³ mm to 100×10⁻³ mm. Further, the sectional area of the spiral groove is preferably in the range of 1×10⁻⁹ m² to 8×10⁻⁹ m². The diameter of the end portion of the capillary 54 is not restricted especially. However, it is preferable 10×10⁻³ mm to 200×10⁻³ mm.

As the probe solution, an aqueous solution of DNA fragment is prepared by dissolving or dispersing probe molecules and water-dissoluble viscosity improver into an aqueous medium, such as distilled water, TE buffer solution (10 mM Toris-HCl/1 mM EDTA), SSC (buffer solution of standard sodium chloride and citric acid), and the like. The viscosity of the aqueous solution is different depending on type of pin to be used. However, it is usually in the range of 1 mPa.s to 100 mPa.s. For example, when the spotting pin 50 is used, the viscosity is preferably in the range of 2 mPa.s to 50 mPa.s, and especially 2 mPa.s to 20 mPa.s. When the water-dissoluble viscosity improver is polymer, it is added such that the weight percentage may be usually in the range of 0.1 wt. % to 5 wt. %, and preferably 0.3 wt. % to 3 wt. %. When the viscosity improver is multiple alcohol or saccharide, it is added such that the weight percentage may be usually 5 wt. % to 50 wt. %, and particularly 10 wt. % to 40 wt. %.

As the water-dissoluble viscosity improver, there are, for example, synthesized or natural water-dissoluble polymers, multiple alcohol (glycerol and the like), saccaride (trehalose, sodium alginate, starch and the like).

In spotting the probe solution, it is necessary to spot such a spot volume of the probe solution that the spotted probe solution may not intrude into the neighboring spot areas. The maximal spot region 16 illustrated in FIG. 3 is an embodiment. However, it is not restricted in FIG. 3. In the present invention, the maximal spot region 16 may be in the range in which the probe solutions do not mix between the neighboring spot areas. Thus when the probe solution is spotted in the maximal spot region 16, it is prevented that the probe solutions mix in the neighboring spot areas.

In the present invention, the spot volume S to the membrane 13 is adequately determined depending on thickness L1 and materials of the substrate, a form and the diameters D of the through holes, the pitch P1 between the neighboring through holes, the distance P2 between the neighboring through holes, sorts of materials and a thickness L2 (see, FIGS. 2&3) of the membrane, an averaged diameter of porous, void ratio in volume P, a spot capacity V of the maximal spot region of the membrane, a form of the spotter (see, FIGS. 11&13), the spot diameter of the spotter, sorts of solvent and the physical properties of the probe solution, and the like. A range of the spot volume S is as follows:
0.01×V×P≦S≦V×P
When the spot volume S is smaller than 0.01×V×P, the labeling is often not made enough, and the data analysis becomes harder. Further, when the spot volume S is larger than V×P, the probe solution spotted in the spot area sometimes mix with that in the neighboring spot areas. Note that the spot capacity V of the maximal spot region is also determined depending on the form of the substrate, and the form of the membrane. In the present invention it is not restricted especially. However, it is preferably in the range of 5×10⁻¹³ m³ to 10×10⁻¹² m³.

For example, the thickness L1 of the substrate 11 is 100 μm, and a stainless plate is used as the material of the substrate 11. Further, the shape of the through holes 12 is circular, and the diameters D thereof are 300 μm. The pitch P1 of the through holes is 400 μm, and the distance P2 between the neighboring through holes is 100 μm. As the membrane 13, a porous adsorptive material having thickness of 180 μm is used. The averages diameter of pores in the porous adsorptive material is 0.45 μm, the averaged void ratio P in volume is 70%. As the spotter, the spotting pin is used, and in order to prepare for the probe solution, the distilled water and the aqueous medium (such as SSC) are used. In these conditions, the spot volume of the membrane in which the probe solution is spotted is at most 8.9×10⁻¹² m³. Thereby the spotting time is at least 0.1 seconds and less than 3 seconds.

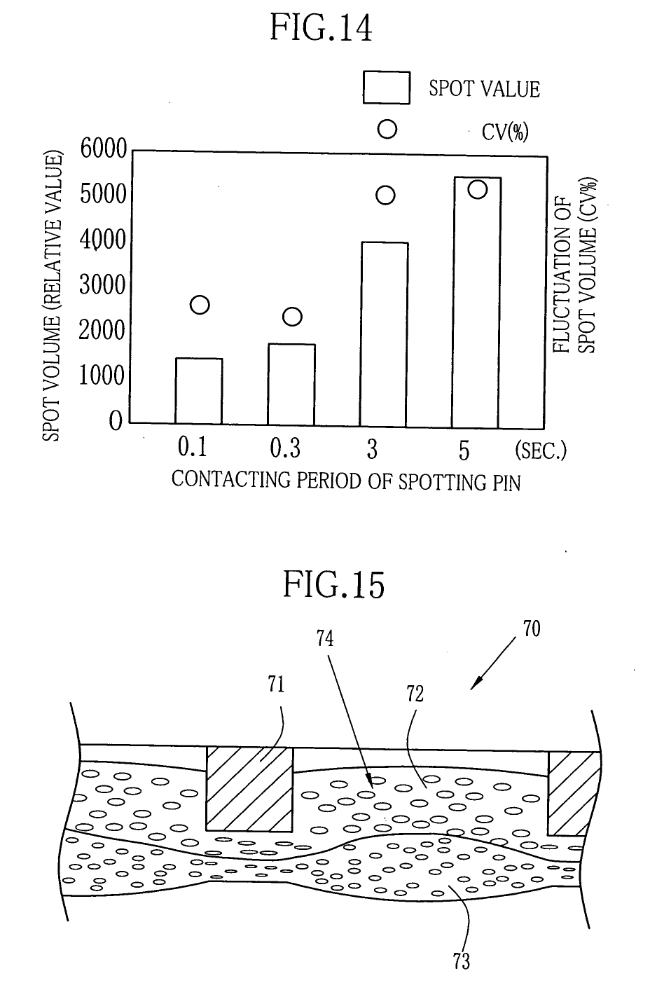

In FIG. 14, a relation of a contacting time of the spotting pin to the membrane surface to relative value of the spot volume. In the examination, the probe solution in which a fluorescent reagent is mixed is used. After the probe solution is spotted on the spot area 14, the fluorescent scanner (FLA-5000, produced by Fuji Photo Film Co., Ltd.) measures the strength of the fluorescence generated from the spot area 14, and calculate the spot volume from the measured values. Note that in this experiment the contacting time of the spotting pin is 0.1 s, the probe solution is spotted onto the 32 spot areas 14, and the average and deviation of the spot volume is calculated from the strength of the fluorescence. A bar graph of the average is illustrated, and the fluctuation of the spot volume (CV=(deviation/average)×100%) is plotted with circles. The contact times are varied to be 0.3 seconds, 3 seconds, and 5 seconds. The spot volume and the fluctuation thereof are shown in each variation.

When a spotting time (or the contacting time of the pin) is shorter than 0.1 second, there is a case that the spot volume of the probe solution to the spot area is smaller than the amount necessary for the analysis. Further, when the spotting time is at least 3 seconds, the spotted probe solution intrudes through the lower side of the membrane into the neighboring spot areas and mixes with the spotted probe solutions in the neighboring spot areas. Accordingly, the spotting time is smaller than 3 seconds to prevent the mixing of the probe solutions and to make the fluctuation of the spot volume smaller (see, FIG. 14). When the predetermined spotting time T2 is determined in the above range, the fluctuation of the spot volume can be made the smallest. Note that the predetermined spotting time T2 is an embodiment of the present invention, and not restricted in the illustrated value.

As shown in FIG. 15, membranes 72, 73 having different properties may be pressed into a substrate 71 of a biochemical analysis unit 70 to form spot areas 74. There are several properties of the membranes. For example, some membranes have different pore ratio in volume, content of functional groups which easily bind with probes, and the like. Note that the number of the membranes is not restricted in two, and may be at least three. When the spot areas 74 are formed, as above described, by using the several sorts of the membrane, the sorts of the probes to be spotted on the membranes in one batch becomes more.

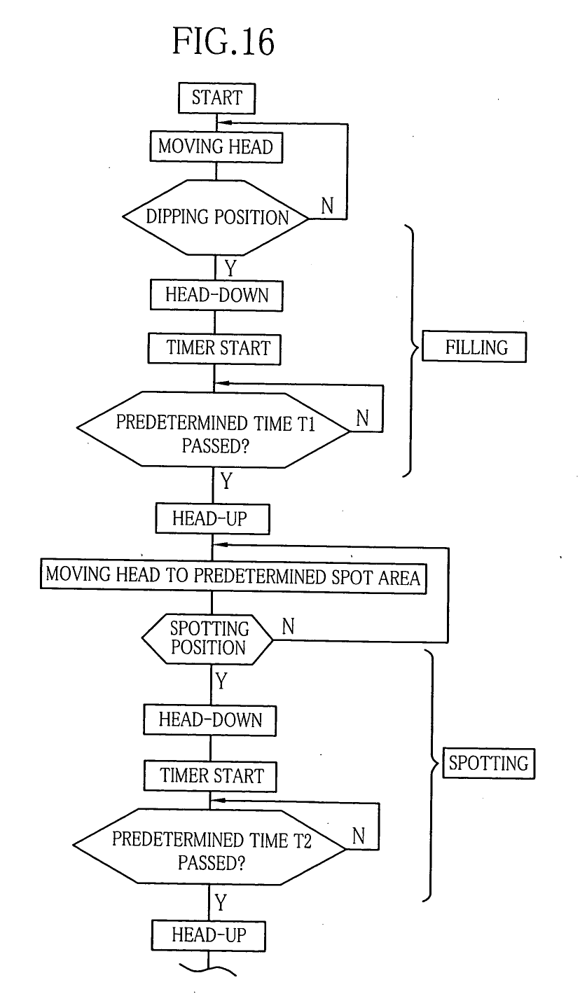

The method of spotting the probe of the present invention is explained in reference with FIGS. 10, 16 & 17. The filling time Ti for filling the groove by soaking-up the objected probe solution and the spotting time T2 corresponding to the spot volume S are predetermined. The spot head 42 is shifted and positioned above the well plate 48 in which each objected probe solution are separately injected. When it is detected that the spot head 42 is moved to a dipping position, the spot head 42 is shifted down. Thereby, the timer circuit 47 starts and thereafter the controller 46 judges whether the predetermined filling time Ti passed. When the predetermined filling time T1 has passed, the spot head 42 is shifted up to end the soaking-up.

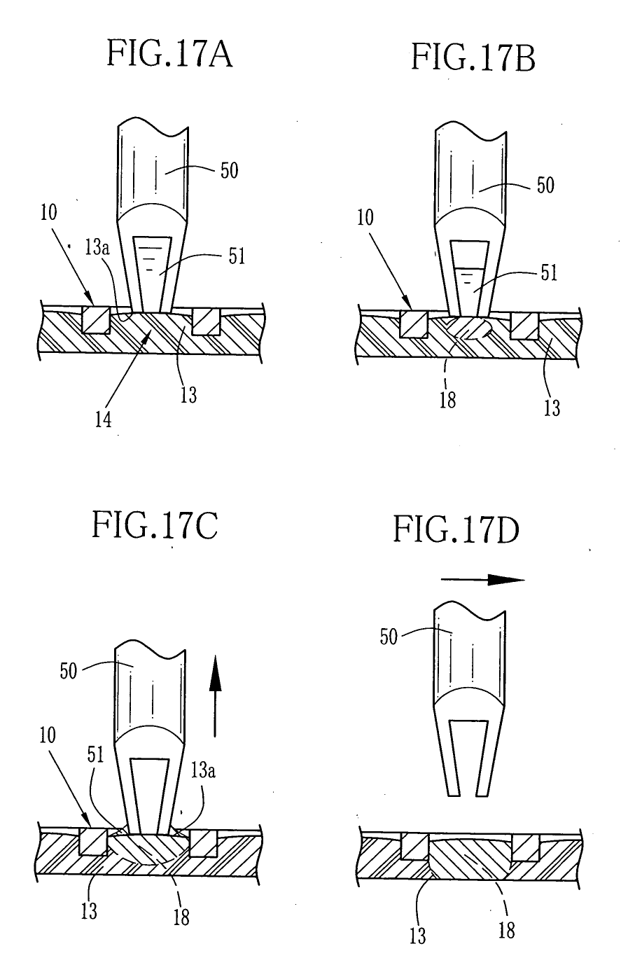

Then the spot head 42 moves to the predetermined spot areas of the biochemical analysis unit 10. When the controller 46 judges that the spot head arrived at the spotting position, the spot head 42 stops moving and is shifted down to start the spotting. Thereby the timer circuit 47 starts. When the spot head 42 is shifted down, as shown in FIG. 17A, the top of the spotting pin 50 contacts to the membrane surface 13a to start spotting. The controller 46 fixedly positions the spotting pins 50 until the predetermined spotting time T2 passes. Thus the probe solution 51 is penetrated into the membrane 13, and as shown in FIG. 17B, a spotting region 18 is extended.

When the predetermined spotting time T2 passes, the spotting head 42 is shifted up such that the spotting of the probe solution onto the membrane 13 by the spotting pin 50 may stop (see, FIG. 17C). Then the probe solution 51 remaining on the membrane surface 13a penetrates into the membrane 13 to form the spotting region 18 as shown in FIG. 17D. Note that the spotting pin 50 is thereafter cleaned and perform the next spotting.

In the embodiment above described in reference with FIGS. 17A-17D is explained the method in which the probe solution on the spotting pin is entirely spotted onto the spot area. However, the present invention is not restricted in the above description. For example, there is a method in which the probe solution in the spotting pin is sequentially spotted into several spot areas. Further, when the predetermined filling time T1 and the predetermined spotting time T2 are set, the descending time of the spot head is preferably considered so as to more strictly control the spot volume S. Further, a droplet of the probe solution 51 on the opening 50b of the spotting pin forms a liquid meniscus to swell, and the supply of the probe solution 51 starts when the droplet contacts to the membrane 13. Therefore, the quantity of the liquid meniscus is preferably considered from materials of the end of the spotting pin 50 and the physical properties of the probe solution 51

Further, the probe solution 51 is soaked up from the end opening into the spotting pin 50 in effect of the capillary phenomenon. Accordingly, the predetermined spotting time T2 is preferably preset so as to leave the end of the spotting pin 50 from the membrane 13 before the probe solution forms the maximal spot region.

The above processes are repeated to obtain the biochemical analysis unit in which the probe solutions are spotted in the spot areas. And the probes are fixed to the membrane in a UV-illumination method. Thereby, it is preferable to make a blocking process in order to prevent the direct adhesion of the target on the surface of the substrate or the spot area in which there are no probe. Thus the generation of the noise from the membrane surface or the surface of the substrate is reduced when the data is read.

The substances derived from living organisms, whose structure is not known, are used as the target. A fluorescent substance is added to the target to make a chemical reaction, whose production is a labeled target. The labeled target is used as a solute for preparing a reaction solution 81. Then a biochemical analysis unit 30 in which the probe is fixed is set to a reactor 80 (see, in FIG. 1) to make a specific binding reaction. In the reactor 80, a pump 83 is driven to circulate the reaction solution 81 into a reaction tank 82, such that the reaction solution 81 may cyclically flow. Therefore the specific binding reaction of the labeled target to the probe fixed to the spot area 32 is easily made, and the data which is excellent in reproducibility and quantitative accuracy can be obtained. However, the reaction may be made with use of a shaking reaction tank.

After the reaction solution forcedly flow across the spot area 32, the flow is preferably interrupted for longer period than that of forcedly flowing. The period of the flow interruption is different depending on sorts and quantities of the probe, target and the like. However, when the period of the flowing is 1 minute to 30 minutes, the period for the flow interruption is preferably 30 minutes to one hour. The flowing and the stop thereof may be cyclically made or repeated. For example, the flowing is forcedly made for one minute, and it is interrupted for 30 minutes, then the flowing is forcedly made for one minute again, and stopped for 30 minutes.

Thereafter, instead of the reaction solution 81, a cleaning liquid (for example super pure water and the like) is fed into the reaction tank 82 to perform the cleaning process in which the reaction solution 81 is removed from the reaction tank 82. Thus the labeling target which made the specific binding reaction with the probe.

After the cleaning process, the biochemical analysis unit 30 is sent to a data reading process, in which biochemical analysis data is photoelectrically read by a scanner 90. The scanner 90 has a light source (not shown) for emitting an excitation light to each spot area 32 and a CCD image sensor 91 for receiving the fluorescence discharged from the labeling substances in illumination of the excitation light. When the fluorescence is received, a photo-electrical conversion is made. A light guide 92 for guiding the fluorescence to light-sensitive elements is provided in front of an acceptance surface of the CCD image sensor 91. The light guide 92 is constructed of plural optical fibers whose number is the same as the spot areas 32. The optical fiber is disposed such that an end may confront to the acceptance surface and another end may confront to the spot area. In the spot area in which the specific binding reaction was made, as the labeling substances remain, the light is generated. However, in other spot area in which the specific binding reaction is not made, the light is not generated. By the CCD image sensor 91, an image data for showing the situation of the specific binding reaction in each spot data 32 is obtained. In the data analysis process, the data for biochemical analysis is made from the image data, and on the basis of the data for biochemical analysis is performed the biochemical analysis.

In the above embodiment, fluorescent substances are used as the labeling substance. However, radioactive substance, chemical reactive labeling substance and the like may be used as the labeling substances. Further, as the labeling method, there are direct and indirect detecting methods. In the direct detecting method, the labeling substances are added with the target and detected in a situation that the labeling substances are added to the reaction solution containing the specific binding substances. In the indirect detecting method, the labeling substances are not added to the reaction solution containing the specific binding substances. The specific binding substances to which the labeling substances are added is bound to the target to which A specific binding reaction of the probe is made.

The products of these two types of the specific binding substances are used for the analysis of the structure of the target. This indirect detecting method is called a sandwiching method, since the target is sandwiched between the probe and the specific binding substance.

Various changes and modifications are possible in the present invention and may be understood to be within the present invention.

1. A method of spotting a probe solution in a spot area which is provided with an adsorptive material in a biochemical analysis unit, said method comprising:
satisfying a condition,
0.01×V×P≦S≦V×P
wherein S is a spot volume (m³) of said probe solution spotted in said spot area, P is a void ratio of said adsorptive material, V is a spot capacity (m³) of a maximal spot region formed by a through hole area and a thickness of said adsorptive material, and said through hole area is said spot area.

2. A method as defined in claim 1, wherein a period for spotting said probe solution to said spot area is at least 0.1 second and less than 3 seconds.
